(19) United States
(12) Patent Application Publication
(10) Pub. No.: US 2012/0163614 A1
(43) Pub. Date: Jun. 28, 2012

(54) SOUND SIGNAL OUTPUT DEVICE, SPEAKER DEVICE, SOUND OUTPUT DEVICE, AND SOUND SIGNAL OUTPUT METHOD

(75) Inventors: Kohei Asada, Kanagawa (JP); Tetsurou Tsukamoto, Kanagawa (JP)

(73) Assignee: Sony Corporation, Tokyo (JP)

(21) Appl. No.: 13/324,082

(22) Filed: Dec. 13, 2011

(30) Foreign Application Priority Data
Dec. 24, 2010 (JP) 2010-286962

(51) Int. Cl. G10K 11/16; H02B 1/00

(52) U.S. Cl. 381/71.1; 381/123

(57) ABSTRACT

A sound signal output device includes a noise cancelling signal generation unit that generates a noise cancelling signal from a sound collecting signal using a microphone provided in a connected speaker device, and a sound signal output processing unit that synthesizes a main sound signal with the noise cancelling signal and amplifies a signal, performs an output limitation process for sound pressure limitation for the main sound signal, and does not perform the output limitation process for the noise cancelling signal, when an output sound signal for a connected speaker device is generated.

### BACKGROUND

The present disclosure relates to a sound signal output device, a speaker device, a sound output device, and a sound signal output method, and, for example, relates to a sound signal output device such as a music reproduction device, and a speaker device such as earphones or headphones.

Japanese Unexamined Patent Application Publication No. 2008-91255, Japanese Unexamined Patent Application Publication No. 11-110704, and Japanese Unexamined Patent Application Publication No. 2010-11117 are examples of the related art.

For example, it has been generalized to enjoy music or the like with a portable reproduction device called an audio player, a media player, or the like.

Here, at present, with regard to music reproduction in an audio player, the reproduction sound pressure tends to be limited to a predetermined sound pressure due to hearing loss countermeasures. For example, the reproduction sound pressure does not exceed a maximum of 85 dBSPL.

For this reason, player and headphones (earphones) manufacturers obey this limitation by limiting a reproduction voltage of an amplifier unit of the player, or sensitivity of the headphones (earphones).

A user generally listens to music by connecting the earphones to the portable audio player, and may arbitrarily combine the audio player with the earphone. Typically, in many cases, the audio player and the earphones are sold together, but the user may use the purchased audio player by connecting other earphones thereto. In addition, the earphone supplied with the audio player may be used during reproduction in other audio players.

Here, as described above, when both of the reproduction voltage limitation setting for an amplifier unit in the audio player side and the sensitivity limitation setting in the earphone side are performed, it is possible to provide a use state obeying the sound pressure limitation even if a user selects any combination.

### SUMMARY

In recent years, a player system having a noise cancelling function has been used. This will be described briefly with reference to FIG. 15A.

FIG. 15A shows a noise cancelling signal generation unit 201, a synthesis circuit 202, and an amplifier 203 as a configuration of the audio player side. In addition, as a configuration of the earphone side, a speaker 101 and a microphone 100 are shown.

In the earphone side installed in the ear ER of the user, sound such as reproduced music is output from the speaker 101, and the microphone 100 for collecting the peripheral incoming noise NZ of the user is installed.

In the audio player side, a sound collecting signal SNZ of the incoming noise collected by the microphone 100 of the earphone side is supplied to the noise cancelling signal generation unit 201 so as to generate a noise cancelling signal SNC. For example, the noise cancelling signal SNC has a phase reverse to the sound collecting signal SNZ.

The synthesis circuit 202 synthesizes an audio signal SA (a main sound signal) which is reproduced by a reproduction system (not shown) with the noise cancelling signal SNC.

The synthesized signal is amplified by the amplifier 203, and is supplied to the speaker 101 as an output signal.

The output sound signal is a synthesized signal of the audio signal SA and the noise cancelling signal SNC. For this reason, the noise cancelling signal SNC and the incoming noise NZ cancel each other out in the space of the ear of the user, and thus the user listens to the audio signal SA in a state where the incoming noise NZ component is greatly reduced.

However, if a configuration supporting the above-described sound pressure limitation is employed, the noise cancelling function does not work sufficiently.

As shown in FIG. 15B, in a case of supporting the sound pressure limitation, for example, a gain is limited by, for example, the amplifier 203. In addition, the speaker 101 has low sensitivity.

In this case, the audio signal SA and the noise cancelling signal SNC synthesized by the synthesis circuit 202 become an amplitude-limited signal due to the gain limitation in the amplifier 203 and reduction in sensitivity in the speaker 101, and reaches the ear of the user.

The audio signal SA reaches the ear of the user as a sound pressure where the sound pressure limitation is obeyed, and thus is appropriate for the hearing loss countermeasures.

However, since the noise cancelling signal SNC is limited in the amplitude, the function of canceling out the incoming noise NZ is deteriorated. That is to say, since the amplitude of the reverse phase signal to the incoming noise NZ is also limited along with the audio signal SA, the incoming noise NZ is not sufficiently cancelled, and the noise NZp remains. In terms of a sense of hearing of the user, the user listens to the audio signal SA in a state where the incoming noise is relatively much.

That is to say, since a noise cancelling waveform with the magnitude to be output for originally cancelling noise may not be reproduced spatially, resultantly, noise cancelling performance is deteriorated. For example, even if a large noise cancelling signal sound corresponding to large noise is attempted to be reproduced, it may not be performed due to output limitation, and thus spatial cancelling of noise becomes insufficient. In addition, the noise cancelling signal is distorted and is easily expressed as different sound. As a result, the user experiences disadvantages.

As such, if the health of the user is to be maintained through the sound pressure limitation, there is a problem in that the noise cancelling function is deteriorated and thus a music listening state of good quality may not be provided to the user.

It is desirable to obey the reproduction sound pressure limitation of music aiming at preventing hearing loss, and to enable a user to listen to music comfortably with noise by heightening noise cancelling performance.

According to an embodiment of the present disclosure, there is provided a sound signal output device including a noise cancelling signal generation unit that generates a noise cancelling signal from a sound collecting signal using a microphone provided in a connected speaker device; and a sound signal output processing unit that synthesizes a main sound signal with the noise cancelling signal and amplifies a signal, performs an output limitation process for sound pressure limitation for the main sound signal, and does not perform the output limitation process for the noise cancelling signal, when an output sound signal for a connected speaker device is generated.

For example, the sound signal output device may further include a connection detection unit that detects whether or not a connected speaker device is a noise cancelling supporting speaker device which outputs a sound collecting signal using the microphone. In addition, the sound signal output processing unit may include a main sound gain circuit that performs a gain process for the main sound signal; a synthesis circuit that synthesizes an output from the main sound gain circuit with the noise cancelling signal; and a power-up circuit that performs an output gain process for an output from the synthesis circuit. In this case, the sound signal output processing unit may make the main sound gain circuit perform the output limitation process and the power-up circuit not perform the output limitation process if connection of the noise cancelling supporting speaker device is detected by the connection detection unit, and, make the main sound gain circuit not perform the output limitation process and the power-up circuit perform the output limitation process if connection of a speaker device other than the noise cancelling supporting speaker device is detected by the connection detection unit.

Alternatively, the sound signal output processing unit may perform the output limitation process using the main sound gain circuit regardless of whether or not a connected speaker device is the noise cancelling supporting speaker device.

According to another embodiment of the present disclosure, there is provided a speaker device including a speaker unit that outputs sound based on an output sound signal supplied from a connected sound signal output device; a microphone that collects incoming noise using a bias voltage supplied from a connected sound signal output device; a switch unit that is installed on a supply path of the output sound signal to the speaker unit and is turned on or off depending on the bias voltage; and a sensitivity reducing resistive element that is connected in parallel to the switch unit on the supply path.

That is to say, according to the embodiments of the present disclosure, by performing the output limitation process for the sound pressure limitation for the main sound signal and not performing the output limitation process for the noise cancelling signal in the sound signal output device side, the noise cancelling function is not deteriorated while obeying the sound pressure limitation.

In addition, in the speaker device as well, it is necessary to output the not-limited noise cancelling signal as it is without reduction. Therefore, when a sound signal output device supporting noise cancelling is connected, sensitivity is made to be high, and, in a case other than that, sensitivity is made to be low. In a case of lowering sensitivity, the switch is turned off, thereby entering a state where the sensitivity reducing resistive element is inserted into the path of the output sound signal, that is, increasing a load along with the speaker load. In a case of heightening sensitivity, the switch is turned on.

According to the embodiments of the present disclosure, in the sound signal output device and the speaker device supporting the sound pressure limitation, it is possible to achieve effects that hearing loss countermeasures of a user are appropriately performed and noise can be sufficiently cancelled by performing output limitation for a main sound signal such as music.

### BRIEF DESCRIPTION OF THE DRAWINGS

FIGS. 1A to 1C are diagrams illustrating connection states according to an embodiment of the present disclosure.

FIG. 2 is a block diagram illustrating an audio player and an earphone according to the embodiment.

FIG. 3 is a diagram illustrating a microphone bias unit according to the embodiment. FIGS. 4A and 4B are diagrams illustrating a plug according to the embodiment and a typical plug.

FIG. 5 is a block diagram illustrating a state where the audio player according to the embodiment is connected to the other earphone.

FIG. 6 is a block diagram illustrating a state where the earphone according to the embodiment is connected to the other audio player.

FIGS. 7A and 7B are diagrams illustrating a gain limitation of a type I of the audio player according to the embodiment.

FIGS. 8A and 8B are diagrams illustrating a gain limitation of a type II of the audio player according to the embodiment.

FIGS. 9A and 9B are diagrams illustrating the amplitude of an output sound signal according to the embodiment.

FIGS. 10A and 10B are diagrams illustrating a switch configuration of the earphone according to the embodiment.

FIGS. 11A and 11B are diagrams illustrating detailed examples of the switch configuration of the earphone according to the embodiment.

FIG. 12 is a diagram illustrating a detailed example of the switch configuration of the earphone according to the embodiment.

FIG. 13 is a flowchart illustrating processes performed by the audio player of the type I.

FIG. 14 is a flowchart illustrating processes performed by the audio player of the type II.

FIGS. 15A and 15B are diagrams illustrating reduction in a noise cancelling function when sound pressure is limited.

### DETAILED DESCRIPTION OF EMBODIMENTS

Hereinafter, embodiments of the present disclosure will be described in the following order. In addition, an audio player will be described as a sound signal output device according to an embodiment of the present disclosure, and an earphone will be described as a speaker device according to an embodiment of the present disclosure.

1. CONNECTION FORM

2. CONFIGURATION OF AUDIO PLAYER AND EARPHONE

3. STATES OF CONNECTION TO OTHER PLAYER AND EARPHONE

4. OUTLINE OF OPERATION OF AUDIO PLAYER (TYPE I AND II)

5. SWITCH CONFIGURATION EXAMPLE OF EARPHONE

6. PROCESS IN AUDIO PLAYER (TYPE I AND II)

7. MODIFIED EXAMPLE

### 1. Connection Form

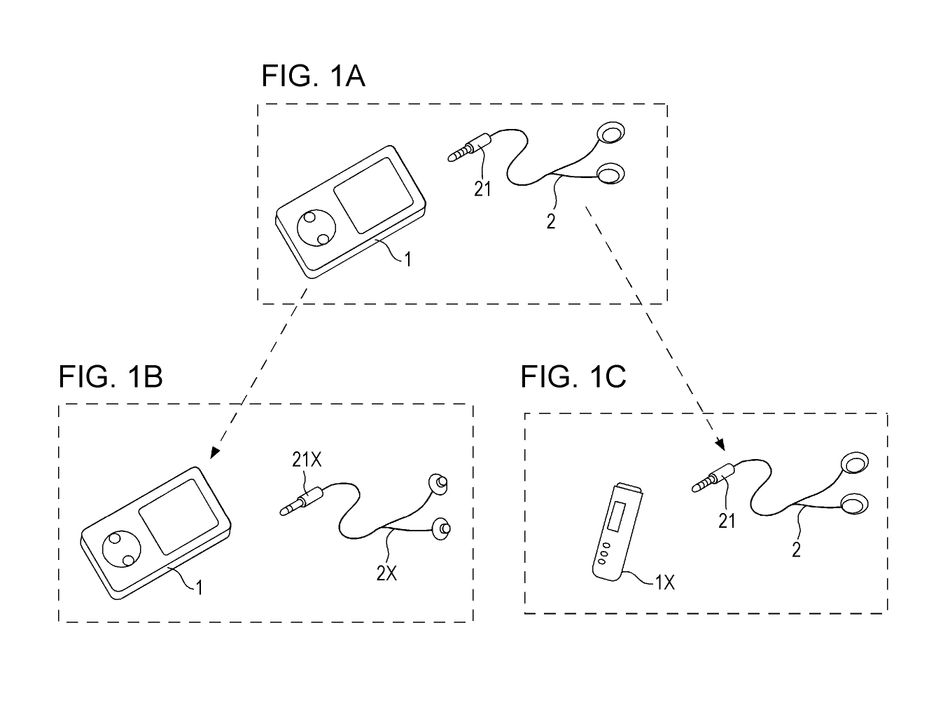

FIGS. 1A to 1C show connection forms of an audio player and an earphone according to the embodiment.

FIG. 1A shows a situation where the audio player 1 and the earphone 2 according to the embodiment are connected to each other and are used.

The audio player 1 according to the embodiment limits an audio signal which is output to the earphone 2 to a predetermined level according to the sound pressure limitation. For example, the maximum output thereof is made to have xdBV.

In addition, the audio player 1 according to the embodiment has a noise cancelling function, and supplies an audio signal and a noise cancelling signal to the earphone 2.

In the earphone 2 according to the embodiment, speaker sensitivity is set according to the sound pressure limitation. For example, the maximum sensitivity is ydBSPL/dBV. However, although described in detail, the earphone 2 has a configuration where sensitivity changes between a high and low states, and is set to high sensitivity in a state of being connected to the audio player 1. As described above, it is in a low sensitivity setting state when the maximum sensitivity is regarded as ydBSPL/dBV, and, in a high sensitivity setting state, an output sound pressure is not limited under the performance of the speaker.

In addition, the earphone 2 is provided with a microphone which collects incoming noise for cancelling noise.

A plug 21 of the earphone 2 is a five-pole plug. A jack portion (not shown) of the audio player 1 includes a five-pole terminal so as to correspond thereto.

For example, the audio player 1 and the earphone 2 according to the embodiment may be sold together.

On the other hand, FIG. 1B shows a situation where another earphone 2X (hereinafter, referred to as “the other earphone 2X”) which does not correspond to the embodiment is connected to the audio player 1 according to the embodiment.

The other earphone 2X is not provided with a microphone for cancelling noise.

In addition, a plug 21X of the other earphone 2X is formed by a three-pole plug which is generally used but can be connected to the audio player 1 according to the embodiment.

The sensitivity (for example, the maximum sensitivity is ydBSPL/dBV) for the sound pressure limitation is also set in the other earphone 2X; however, an earphone in the related art which does not support the sound pressure limitation may be the other earphone 2X. At least an audio player 1 side performs an output limitation due to the sound pressure limitation, and thus sound is output in accordance with the sound pressure limitation.

FIG. 1C shows a situation where the earphone 2 according to the embodiment is connected to another audio player 1X (hereinafter, referred to as “the other player 1X”) which does not correspond to the embodiment.

The other player 1X is an audio player which does not have the noise cancelling function. The earphone 2 is the above-described five-pole plug but can be connected to a jack portion of the other player 1X.

In addition, the earphone 2 is set to low sensitivity, that is, has a setting according to the sound pressure limitation, in a state of connection to the other player 1X.

The output limitation (for example, the maximum output is xdBV) for the sound pressure limitation is also set in the other player 1X; however, an audio player in the related art which does not support the sound pressure limitation may be the other player 1X. At least an earphone 2 side has the sensitivity setting according to the sound pressure limitation, and thus sound is output in accordance with the sound pressure limitation.

It is expected that a user side uses the audio player 1 or the earphone 2 according to the embodiment in these connection forms.

In a case where the player output limitation and the speaker sensitivity setting are performed according to the sound pressure limitation, it has been described above that the noise cancelling function does not work sufficiently.

Here, in the respective forms shown in FIGS. 1A to 1C, the cases in FIGS. 1B and 1C do not cause a problem of the noise cancelling function. This is because the other player 1X and the other earphone 2X originally do not have the noise cancelling function.

In the connection form shown in FIG. 1B, the audio player 1 preferably performs the output limitation according to the sound pressure limitation.

In addition, in the connection form shown in FIG. 1C, the earphone 2 preferably has the speaker sensitivity setting according to the sound pressure limitation.

However, in the connection form shown in FIG. 1A, the noise cancelling function does not work sufficiently in this state.

This is because although a noise cancelling signal is superimposed on an audio signal, an output of the noise cancelling signal is also limited and the speaker sensitivity is lowered, which decreases reverse-phase sound due to the noise cancelling signal, and thus an output for sufficiently cancelling out incoming noise may not be obtained in the audio player 1.

In the audio player system having the noise cancelling function described here, the reproduction sound pressure of music at the ear is necessary to be suppressed just as the limitation under the sound pressure limitation (including voluntary limitation) for preventing hearing loss, when noise cancelling is simultaneously performed at the time of reproducing the music. However, the sound pressure of the noise cancelling signal corresponding to a reverse-phase component of noise, simultaneously reproduced by the corresponding system resultantly cancels out the noise at the ear and thus does not have relation to the sound pressure limitation itself. Particularly, noise cancelling performance is deteriorated unless the same reverse-phase signal component is reproduced with the same large sound pressure under large noise, which thus is not preferable.

Therefore, the embodiment employs the following configuration.

The audio player 1 according to the embodiment performs synthesis of a main sound signal (for example, a reproduction signal of music or the like) and a noise cancelling signal and signal amplification, and generates a sound signal output to a connected speaker device. At this time, the main sound signal undergoes an output limitation process for the sound pressure limitation, and the noise cancelling signal does not undergo the output limitation process.

In addition, in the earphone 2 according to the embodiment, a sensitivity reducing resistive element is disposed on a supply path of the output sound signal from the audio player 1 (or the other player 1X) to the speaker portion. This lowers the speaker sensitivity so as to obey the sound pressure limitation. However, in a case where the audio player 1 is connected, a switch unit installed in parallel with the sensitivity reducing resistive element is turned on so as to inactivate the sensitivity reducing resistive element, thereby heightening the speaker sensitivity. That is to say, the noise cancelling signal of which an output is not limited in the audio player 1 side is output within the maximum output sound pressure of the speaker performance (that is, the maximum output sound pressure which is not limited) in the earphone 2 side as well.

In this way, the reproduction sound pressure limitation of music for preventing hearing loss is obeyed, and the noise cancelling performance is shown, thereby providing listening circumstances capable of listening to music or the like comfortably with noise, to a user.

### 2. Configuration of Audio Player and Earphone

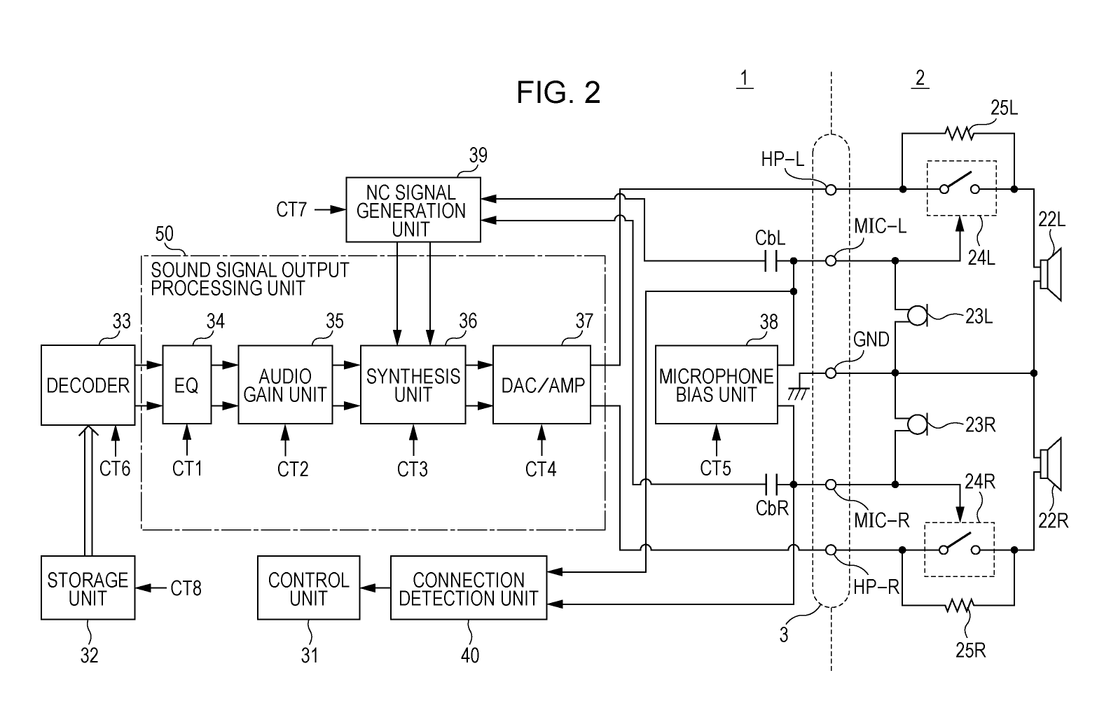

A configuration example of the audio player 1 and the earphone 2 according to the embodiment will be described with reference to FIG. 2. FIG. 2 shows each constituent element in a state where the audio player 1 is connected to the earphone 2 and is used, described in FIG. 1A.

In addition, “noise cancelling” is hereinafter abbreviated to “NC” in some cases. In addition, a player system formed by the audio player 1 and the earphone 2 will be described as a two-channel stereo system of an L channel and an R channel.

In addition, although, in relation to the NC function, an example of employing a feedforward scheme is described, an NC process of a feedback scheme may be performed.

The earphone 2 includes speakers 22L and 22R, microphones 23L and 23R, switch portions 24L and 24R, and sensitivity reducing resistors 25L and 25R so as to correspond to the L and R channels.

In addition, although it has been described that the plug 21 of the earphone 2 is a five-pole plug, and the jack (not shown) of the audio player 1 corresponds to the five-pole plug in FIG. 1A, FIG. 2 shows only a connection terminal part as a plug/jack 3.

As five-pole terminals, an L channel terminal HP-L, an R channel terminal HP-R, a ground terminal GND, a microphone terminal MIC-L, and a microphone terminal MIC-R are provided.

The speaker 22L is connected between the L channel terminal HP-L and the ground terminal GND.

The switch portion 24L and the sensitivity reducing resistor 25L are connected in parallel to each other on an L channel output sound signal path between the L channel terminal HP-L and the speaker 22L.

The speaker 22R is connected between the R channel terminal HP-R and the ground terminal GND.

The switch portion 24R and the sensitivity reducing resistor 25R are connected in parallel to each other on an R channel output sound signal path between the R channel terminal HP-R and the speaker 22R.

As only an example, the speakers 22L and 22R have a speaker load of 16 Ω. and the sensitivity reducing resistors 25L and 25R of 16 Ω.

The microphones 23L and 23R are installed at a predetermined position in the earphone 2 so as to collect incoming noise. For example, the microphones are installed outward the casing of the earphone 2 and collects incoming noise. As the microphones 23L and 23R, for example, electret condenser microphones are used.

The microphone 23L is connected between the microphone terminal MIC-L and the ground terminal GND.

The microphone 23R is connected between the microphone terminal MIC-R and the ground terminal GND.

A voltage of the microphone terminal MIC-L is used to control turning-on and turning-off of the switch portion 24L. In a similar manner, a voltage of the microphone terminal MIC-R is used to control turning-on and turning-off of the switch portion 24R.

The audio player 1 includes a control unit 31, a storage unit 32, a decoder 33, a sound signal output processing unit 50, a microphone bias unit 38, an NC signal generation unit 39, and a connection detection unit 40.

The control unit 31 is constituted by, for example, a microcomputer, controls the respective parts according to a program and a user operation from an operation unit (not shown), and executes an reproduction sound signal output and the like.

The storage unit 32 is a part storing audio data such as music content. The storage unit 32 is constituted by a nonvolatile memory, an HDD (Hard Disk Drive), or the like, stores music content or the like, and can read the content.

In addition, the storage unit 32 may be configured as a reproduction unit for a medium such as a memory card which stores music content, or an optical disc.

The storage unit 32 stores music content data or the like as, for example, compression data, and reads designated music content in response to a control signal CT8 from the control unit 31.

The music content data read from the storage unit 32 is supplied to the decoder 33. The decoder 33 performs a necessary decoding process in response to a control signal CT6 from the control unit 31. For example, the decoder 33 performs decompression decoding for the compression data.

The decoder 33 performs the necessary decoding process, and, for example, outputs an audio signal (a main sound signal) as linear PCM data of each of the L and R channels.

The sound signal output processing unit 50 performs a process for the audio signal of each of the L and R channels output from the decoder 33 so as to be output to the earphone 2.

The sound signal output processing unit 50 includes an equalizer 34, an audio gain portion 35, a synthesis portion 36, and a DAC and amplifier portion 37.

The equalizer 34 performs sound quality correction such as amplitude-frequency characteristic correction, phase-frequency characteristic correction, or both of them.

The correction process in the equalizer 34 is performed based on a control signal CT1 from the control unit 31. For example, an instruction of the frequency characteristic or the like is performed based on a control signal SG3CT1.

The audio gain portion 35 amplifies the audio signal. A given gain is instructed using a control signal CT2 from the control unit 31.

In this example, the audio gain portion 35 may set a value of the gain to a limitation value according to the sound pressure limitation.

The synthesis portion 36 synthesizes (adds) NC signals of the L and R channels with the audio signals of the L and R channels. The synthesis portion 36 performs the synthesis process based on a control signal CT3 from the control unit 31. The control unit 31 instructs the synthesis portion 36 to perform the synthesis process when the noise cancelling function is performed. In addition, in a case where a user makes the noise cancelling function enter an OFF state, the control unit 31 instructs the synthesis portion 36 not to perform the synthesis process.

The DAC and amplifier portion 37 performs a D/A conversion process and a power-up amplification for output for the audio signals (synthesized signal) of the L and R channels output from the synthesis portion 36, and obtains an output sound signal.

The process in the DAC and amplifier portion 37 is performed based on a control signal CT4 from the control unit 31.

In this example, the DAC and amplifier portion 37 may set a value of the gain of the power-up amplification process to a limitation value according to the sound pressure limitation in some cases.

The output sound signal of the L channel (the audio signal and the NC signal) which is output from the DAC and amplifier portion 37 is supplied to the speaker 22L via the L channel terminal HP-L of the plug/jack 3, and is output as sound.

The output sound signal of the R channel (the audio signal and the NC signal) which is output from the DAC and amplifier portion 37 is supplied to the speaker 22R via the R channel terminal HP-R of the plug/jack 3, and is output as sound.

In addition, the DAC and amplifier portion 37 may perform an analog power-up process after D/A conversion, or may perform a digital amplification process.

The microphone bias unit 38 applies a microphone bias voltage to the microphone terminals MIC-L and MIC-R in response to a control signal CT5 from the control unit 31. That is to say, a bias voltage is applied to the microphones 23L and 23R of the connected earphone 2.

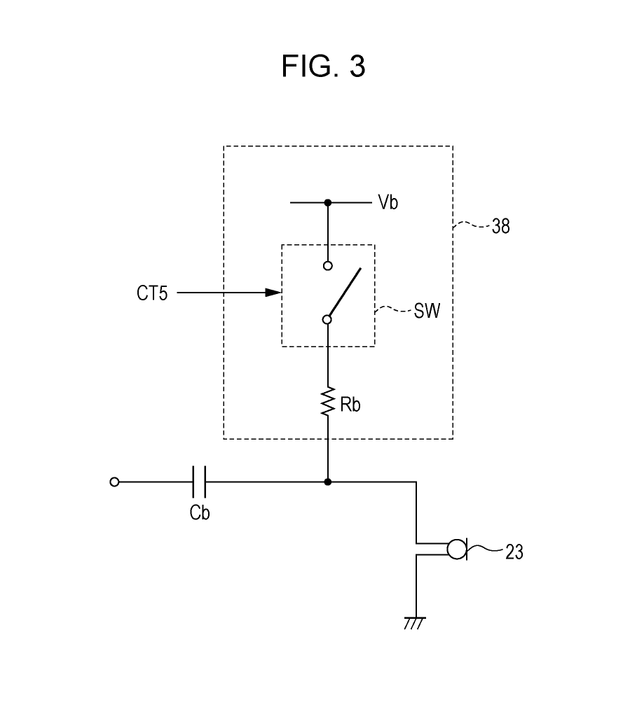

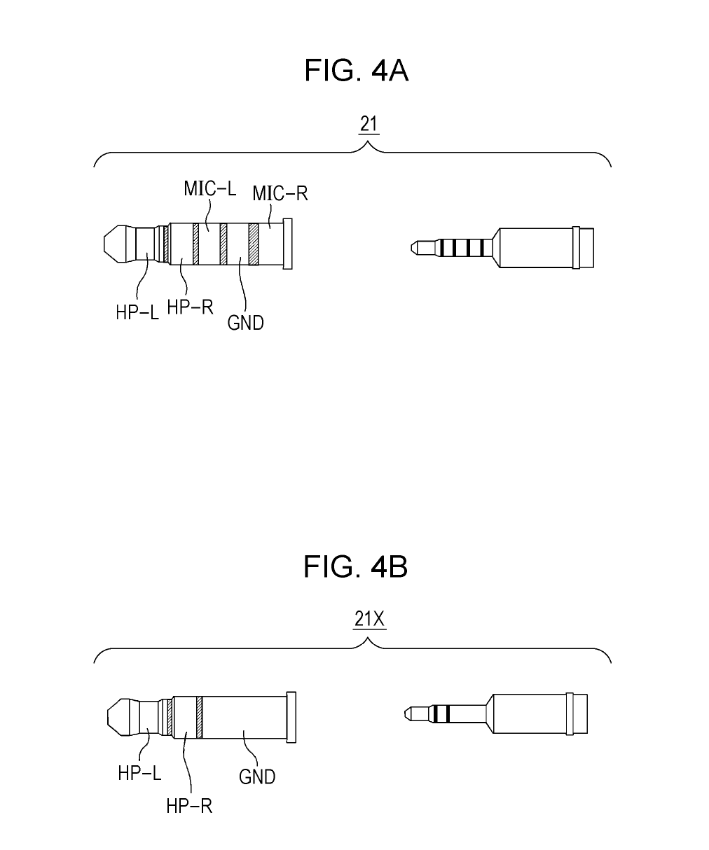

The microphone bias unit 38 applies the bias voltage Vb to the microphones 23 (23L and 23R) via a switch SW and a resistor Rb, for example, as shown in FIG. 3. That is to say, the switch SW is turned on in response to the control signal CT5 from the control unit 31, and thus the bias voltage is applied.

For example, the microphones 23 (23L and 23R) as an electret condenser microphone perform a sound collecting operation when the bias voltage is applied, and a sound collecting signal thereof appears at a bias line.

The sound collecting signal obtained by the microphones 23L and 23R is supplied to the NC signal generation unit 39. That is to say, the bias voltage part of the bias line is cut off by capacitors CbL and CbR for DC cut-off, and thereby a sound collecting signal component, that is, an incoming noise signal is supplied to the NC signal generation unit 39.

The NC signal generation unit 39 generates an NC signal from the sound collecting signal obtained by the microphones 23L and 23R. For example, the NC signal generation unit 39 performs an A/D conversion for the sound collecting signal of each channel, and generates an NC signal having a reverse phase waveform for cancelling out the incoming noise through a digital filter process for the digitalized sound collecting signal of each channel.

The generated NC signal of each channel is supplied to the synthesis portion 36, and is synthesized with the audio signal of each channel as described above.

The connection detection unit 40 monitors voltages of the microphone terminals MIC-L and MIC-R and thus determines whether a connected earphone is the earphone 2 or the other earphone 2X. As described later, if the other earphone 2X is connected, the microphone terminals MIC-L and MIC-R are short-circuited to the ground terminal GND, and thereby determination of a connected earphone is possible through the voltage monitoring of the microphone terminals MIC-L and MIC-R.

The connection detection unit 40 notifies the control unit 31 of a detected result of whether a connected earphone is the earphone 2 or the other earphone 2X.

Here, the plug 21 of the earphone 2 will be described with reference to FIG. 4A. In addition, FIG. 4B shows a general plug 21X used in the other earphone 2X.

The plug 21 of the earphone 2 according to the embodiment has a five-pole terminal configuration as shown in FIG. 4A, and thereby, as shown in FIG. 2, the L channel terminal HP-L, the R channel terminal HP-R, the ground terminal GND, and the microphone terminals MIC-L and MIC-R are formed.

The jack portion of the audio player 1 is provided with terminals corresponding to the five-pole terminals, and thus the connection state indicated by the plug/jack 3 in FIG. 2 is formed.

Here, the plug 21 has the same overall shape as the typical plug 21X, and thus the plug 21 can be connected to the other player 1X having the three-pole terminal configuration.

In addition, conversely, the typical plug 21X can be connected to the jack portion of the audio player 1 according to the embodiment.

The microphone terminals MIC-L and MIC-R in the plug 21 are formed at a position corresponding to the ground terminal GND part in the typical plug 21X.

Therefore, if the plug 21 is connected to the other player 1X, the microphone terminals MIC-L and MIC-R and the ground terminal GND come into contact with the ground terminal of the jack of the other player 1X. That is to say, when the earphone 2 is connected to the other player 1X, the microphone terminals MIC-L and MIC-R of the earphone 2 are short-circuited to the ground terminal.

In addition, on the other hand, if the other earphone 2X having the typical plug 21X is connected to the audio player 1, the microphone terminals MIC-L and MIC-R and the ground terminal GND which are terminals of the jack side of the audio player 1 come into contact with the ground terminal GND of the plug 21X. That is to say, when the other earphone 2X is connected to the audio player 1, the microphone terminals MIC-L and MIC-R of the jack of the audio player 1 are short-circuited to the ground terminal.

### 3. States of Connection to Other Player and Earphone

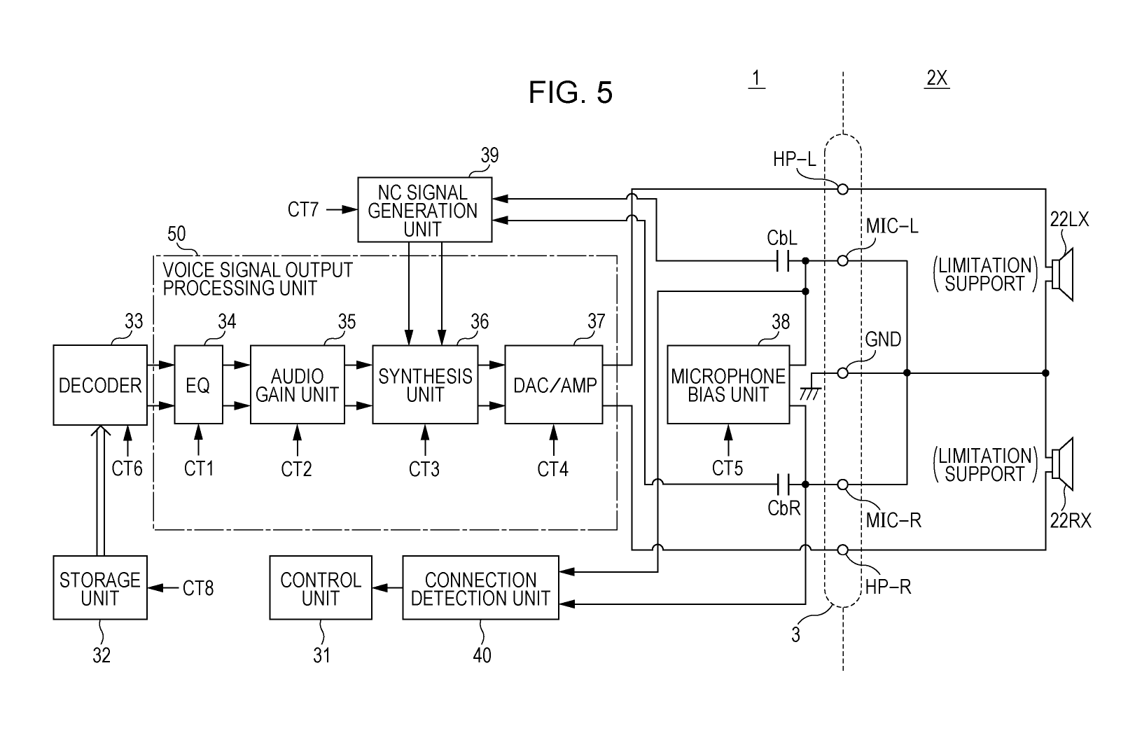

FIG. 5 shows a state where the other earphone 2X is connected to the audio player 1 according to the embodiment. That is to say, FIG. 5 shows the case of use form described in FIG. 1B.

The earphone 2X includes speakers 22LX and 22RX so as to correspond to the L and R channels.

The speaker 22LX is connected between the L channel terminal HP-L and the ground terminal GND.

The speaker 22RX is connected between the R channel terminal HP-R and the ground terminal GND.

The speakers 22LX and 22RX of the other earphone 2X have low sensitivity (for example, a speaker of 32 Ω).

In addition, the plug 21X of the other earphone 2X is the above-described three-pole plug. Therefore, the microphone terminals MIC-L and MIC-R provided on the jack of the audio player 1 side are short-circuited to the ground terminal GND in the connection terminal part as the plug/jack 3 in FIG. 5.

In this case, the other earphone 2X does not have the NC function. Therefore, the audio player 1 side does not perform the process where the microphone bias voltage is given to the other earphone 2X or the NC signal is generated by inputting a sound collecting signal of incoming noise, and the microphone terminals MIC-L and MIC-R are not used.

As described later, in the audio player 1 side, the connection detection unit 40 detects connection of the other earphone 2X when the microphone terminals MIC-L and MIC-R have a ground potential. The control unit 31 controls the microphone bias voltage not to be supplied in response thereto, and controls the NC signal not to be generated.

The sound signal output processing unit 50 limits a gain for an audio signal in order to obey the sound pressure limitation. In addition, the speakers 22LX and 22RX have low sensitivity, thereby obeying the sound pressure limitation.

Therefore, even if a user uses the audio player 1 and the other earphone 2X in a connection state shown in FIG. 5, excessively large sound may not be output.

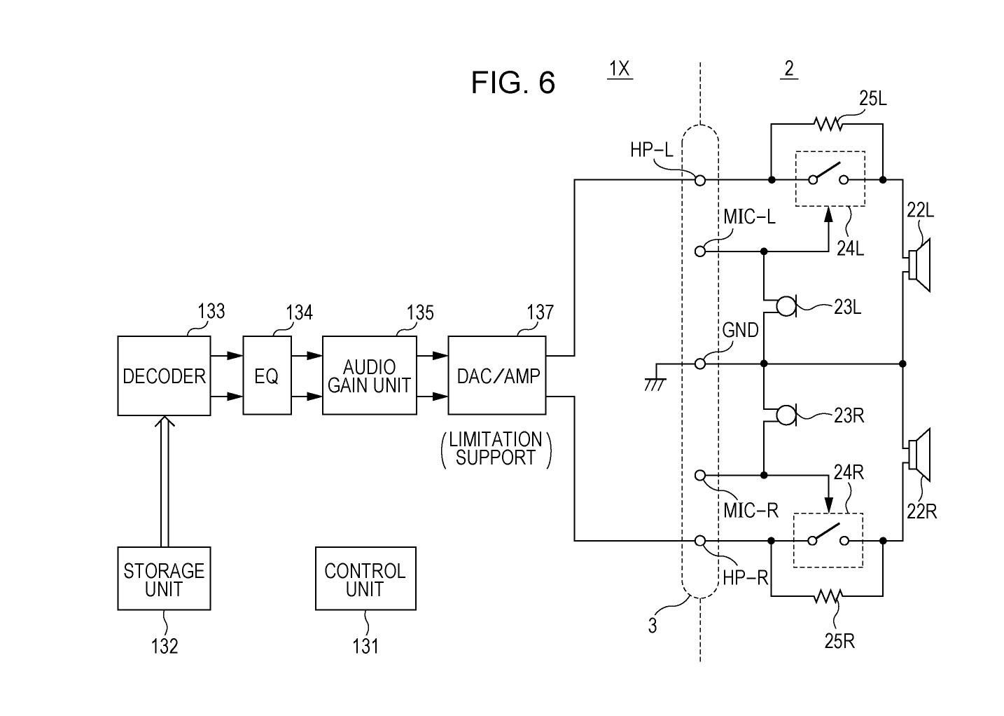

On the other hand, FIG. 6 shows a state where the earphone 2 according to the embodiment is connected to the other player 1X. That is to say, FIG. 6 shows the case of the use form described in FIG. 1C.

The other player 1X decodes music content data read from a storage unit 132 using a decoder 133. In addition, decoded audio signals of the L and R channels are processed by an equalizer 134, an audio gain portion 135, and a DAC and amplifier portion 137. The audio signals of the L and R channels are supplied to the earphone 2 from the L channel terminal HP-L and the R channel terminal HP-R. A control unit 131 controls the respective parts so as to perform the above-described operations.

The other player 1X does not have the NC function, and thus the microphones 23L and 23R on the earphone 2 side are not used. Naturally, the noise cancelling operation is not performed.

A gain for the audio signal is limited, for example, at the power-up stage of the DAC and amplifier portion 137 in order to obey the sound pressure limitation. In addition, as described later, the switch portions 24L and 24R of the earphone 2 are turned off.

The speakers 22L and 22R have high sensitivity (for example, 16 Ω); however, the switch portions 24L and 24R are turned off, and thereby the audio signals of the L and R channels are supplied to the speakers 22L and 22R via the sensitivity reducing resistors 25L and 25R (for example, 16 Ω). Therefore, the speaker impedance corresponds to 32 Ω. when seen from the other player 1X, and is equivalent to a speaker of low sensitivity according to the sound pressure limitation.

Therefore, even if a user uses the other player 1X and the earphone 2 in a connection state shown in FIG. 6, excessively large sound may not be output.

### 4. Outline of Operation of Audio Player (Type I and II)

As shown in FIGS. 5 and 6, in a case where the audio player 1 or the earphone 2 according to the embodiment is connected to the other earphone 2X or the other player 1X and is used, the noise cancelling operation is not originally performed, and thus a problem that the noise cancelling function is deteriorated does not occur even if the sound pressure limitation is performed.

However, in a case of using a set of the audio player and the earphone having the noise cancelling function, it has been described that the noise cancelling function is deteriorated due to the sound pressure limitation.

Therefore, even when connected to any earphone, the audio player 1 according to the embodiment supports the sound pressure limitation, and enables the NC function to be appropriately expressed when connected to the earphone 2 according to the embodiment.

Two examples of the operation of the audio player 1 will be described as types I and II.

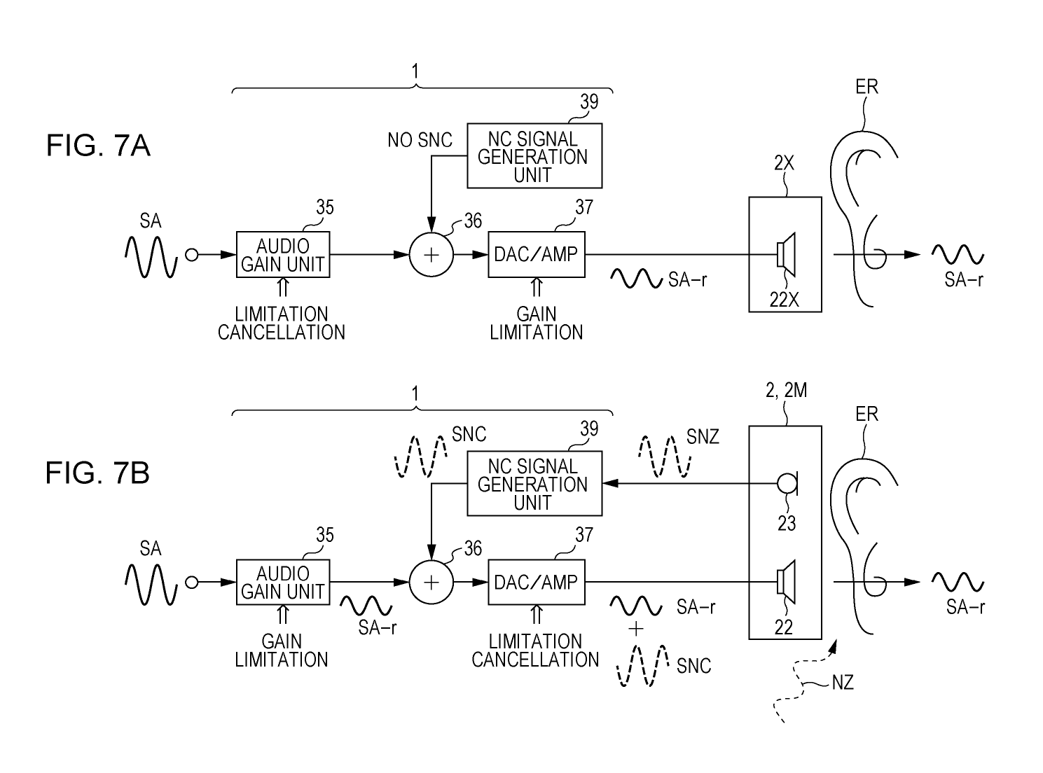

FIGS. 7A and 7B schematically show an operation as the type I.

FIG. 7A shows a case where the audio player 1 is connected to the other earphone 2X. As described with reference to FIG. 5, the NC signal generation unit 39 does not generate the noise cancelling signal SNC. The audio signal SA is amplified by the audio gain portion 35, does not undergo the synthesis with the noise cancelling signal SNC in the synthesis portion 36, and is amplified by the DAC and amplifier portion 37 so as to be supplied to the speakers 22X (22LX and 22RX) of the other earphone 2X.

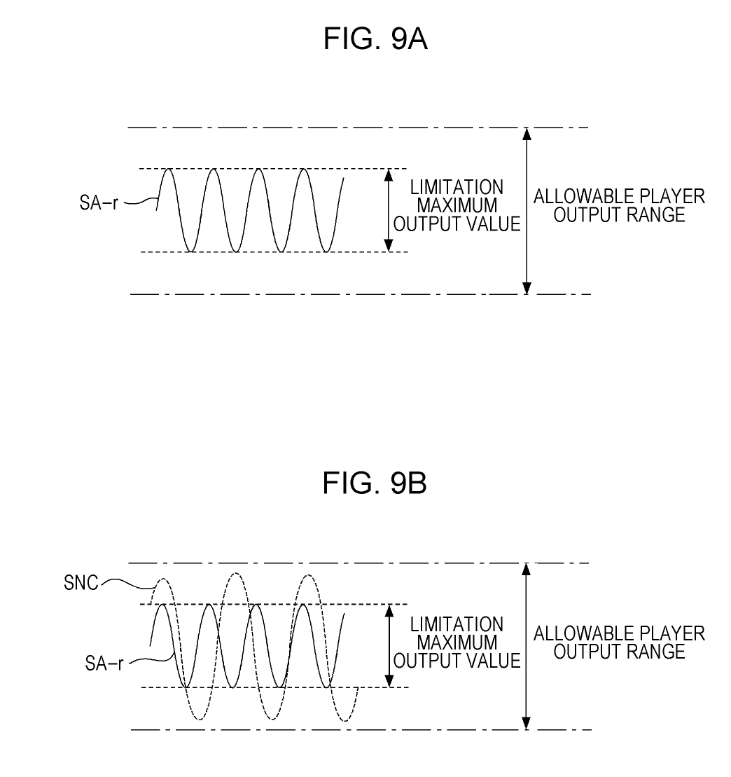

In this case, in the audio player 1 side, the gain limitation is not particularly performed in the audio gain portion 35, and the gain limitation is performed at the time of the power-up process in the DAC and amplifier portion 37. Thereby, an audio signal SA-r of which the amplitude is limited within the limitation maximum output value as shown in FIG. 9A is supplied to the other earphone 2X. In addition the speakers 22X also have low sensitivity. Therefore, an excessive sound volume is not output.

FIG. 7B shows a case where the audio player 1 is connected to the earphone 2. That is to say, FIG. 7B shows the state shown in FIG. 2.

In this case, the noise cancelling signal SNC is output from the NC signal generation unit 39 and is supplied to the synthesis portion 36.

The audio signal SA is amplified by the audio gain portion 35, is synthesized with the noise cancelling signal SNC in the synthesis portion 36, and is amplified by the DAC and amplifier portion 37. Then, the amplified signal is supplied to the speakers 22 (22L and 22R) of the earphone 2.

In this case, the audio player 1 side limits a gain using the audio gain portion 35. On the other hand, a gain is not limited at the time of the power-up process in the DAC and amplifier portion 37.

Thereby, as shown in FIG. 9B, the audio signal SA-r of which the amplitude is limited within the limitation maximum output value and the noise cancelling signal SNC of which the amplitude is not limited in an allowable player output range are supplied to the earphone 2. As described later, the speakers 22 are in a high sensitivity state.

Therefore, the audio signal is not output with an excessive sound volume, but the noise cancelling signal SNC may be output with a sound pressure exceeding the limitation. As a result, the noise cancelling signal SNC appropriately cancels out the noise sound, and thereby the NC effect is appropriately achieved. Of course, even if the noise cancelling signal SNC is output with a sound pressure exceeding the limitation, the noise cancelling signal SNC cancels out the incoming noise in the space, and thus an excessive sound pressure is not applied to a sense of hearing of a user.

In addition, this is also true of a case where an earphone 2M having the microphones 23 for cancelling noise is connected even if the earphone 2 according to the embodiment is not connected.

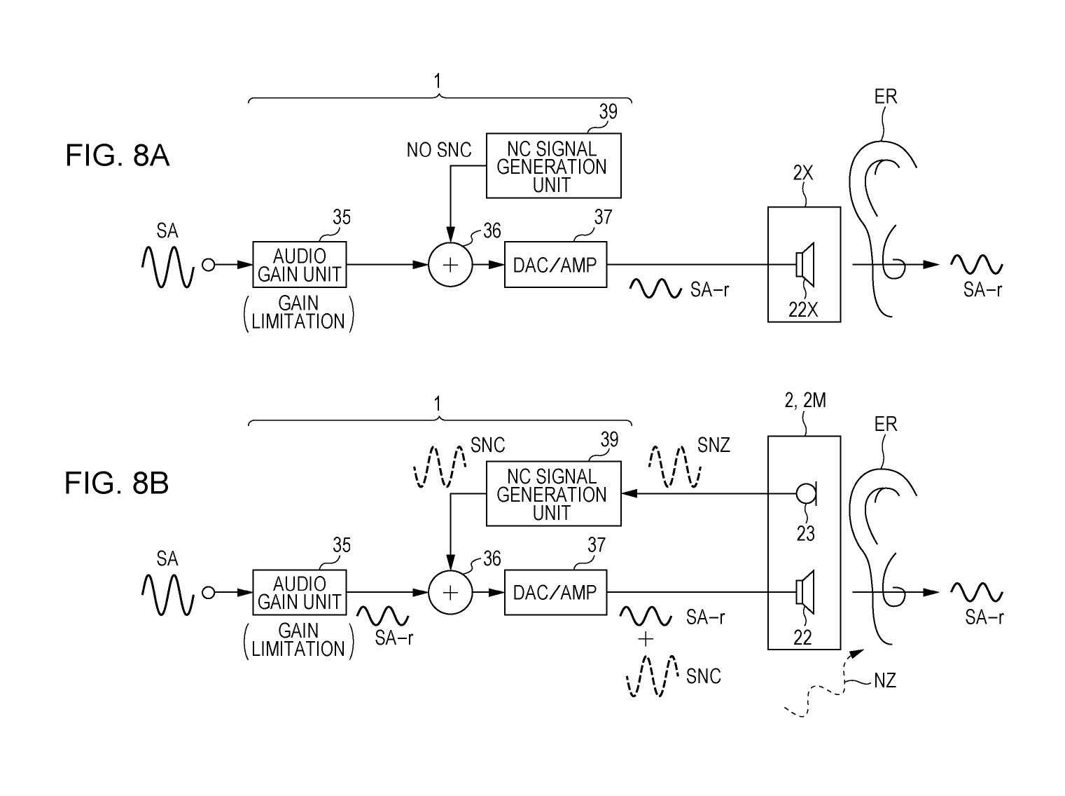

Next, an operation as the type II will be described with reference to FIGS. 8A and 8B.

FIG. 8A shows a case where the audio player 1 is connected to the other earphone 2X. In this case, the NC signal generation unit 39 does not generate the noise cancelling signal SNC. The audio signal SA is amplified by the audio gain portion 35, does not undergo the synthesis with the noise cancelling signal SNC in the synthesis portion 36, and is amplified by the DAC and amplifier portion 37 so as to be supplied to the speakers 22X (22LX and 22RX) of the other earphone 2X.

In the type II, the audio player 1 side normally limits a gain using the audio gain portion 35. The DAC and amplifier portion 37 does not limit a gain at the time of the power-up process.

Thereby, an audio signal SA-r of which the amplitude is limited within the limitation maximum output value as shown in FIG. 9A is supplied to the other earphone 2X. In addition the speakers 22X also have low sensitivity. Therefore, an excessive sound volume is not output.

FIG. 8B shows a case where the audio player 1 is connected to the earphone 2. That is to say, FIG. 8B shows the state shown in FIG. 2.

In this case, the noise cancelling signal SNC is output from the NC signal generation unit 39 and is supplied to the synthesis portion 36.

The audio signal SA is amplified by the audio gain portion 35, but may undergo the gain limitation. Then, the audio signal SA is synthesized with the noise cancelling signal SNC in the synthesis portion 36, is amplified in the DAC and amplifier portion 37, and is supplied to the speakers 22 (22L and 22R) of the earphone 2.

Thereby, as shown in FIG. 9B, the audio signal SA-r of which the amplitude is limited and the noise cancelling signal SNC of which the amplitude is not limited are supplied to the earphone 2. The speakers 22 are in a high sensitivity state.

Therefore, the audio signal is not output with an excessive sound volume, but the noise cancelling signal SNC may be output with a sound pressure exceeding the limitation. In other words, in a manner similar to the type I, the NC effect is appropriately achieved.

### 5. Switch Configuration Example of Earphone

Next, an operation of the earphone 2 side according to the embodiment will be described.

The earphone 2 according to the embodiment functions as a sound pressure limitation supporting speaker when connected to the other player 1X which does not have the noise cancelling function, and enables the NC function to be appropriately expressed when connected to the audio player 1 according to the embodiment.

As described with reference to FIG. 2, in the earphone 2, the switch portions 24L and 24R and the sensitivity reducing resistors 25L and 25R are connected in parallel to each other on the audio signal path to the speakers 22L and 22R.

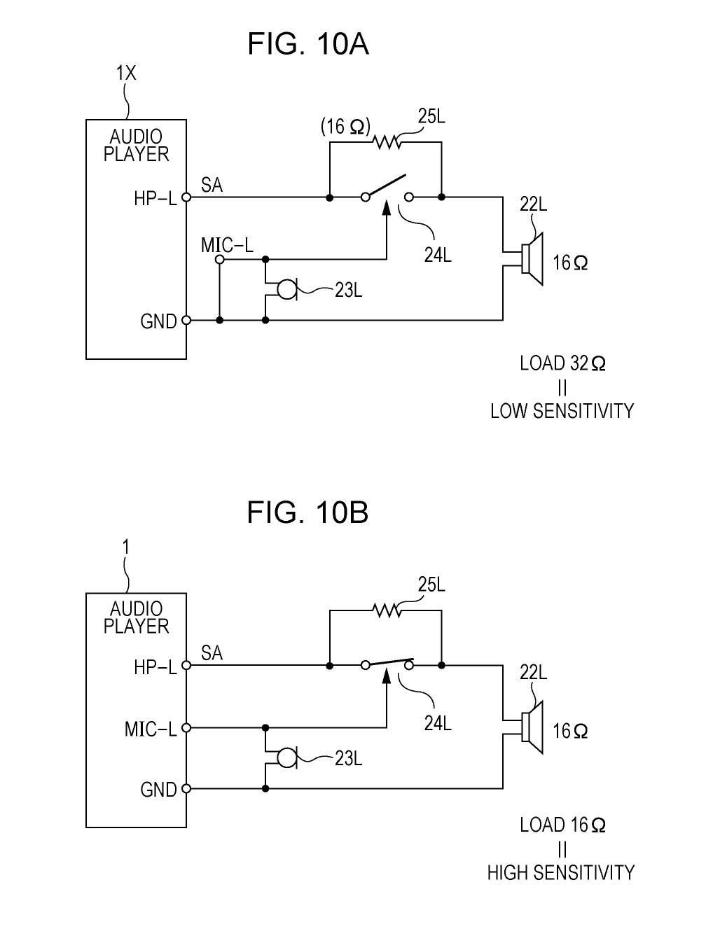

An operation of the switch portions 24L and 24R will be described with reference to FIGS. 10A and 10B. In addition, FIGS. 10A and 10B show only the L channel side. The R channel side also has the similar configuration.

FIG. 10A shows a state where the earphone 2 is connected to the other player 1X. That is to say, FIG. 10A shows the state shown in FIG. 6. At this time, the microphone terminal MIC-L of the plug 21 is not applied with the bias voltage and is short-circuited to the ground terminal GND. Thereby, the switch portion 24L is turned off.

Therefore, the sensitivity reducing resistor 25L of, for example, 16 Ω is connected in series to the speaker 22L which, in this case, functions as a speaker device of the load 32 Ω (low sensitivity). Thereby, the sound pressure limitation is appropriately performed.

FIG. 10B shows a state where the earphone 2 is connected to the audio player 1. That is to say, FIG. 10B shows the state shown in FIG. 2. At this time, the microphone terminal MIC-L is applied with the bias voltage from the microphone bias unit 38 of the audio player 1. Thereby, the switch portion 24L is turned on.

Therefore, the sensitivity reducing resistor 25L in this case is by-passed, and the speaker 22L functions as a speaker device having high sensitivity of only the load 16 Ω.

In the audio player 1 side, as described with reference to FIGS. 7A and 7B or 8A and 8B, the gain limitation is given to the audio signal, and thus a sound pressure exceeding the sound pressure limitation is not output in relation to the audio signal even in a case of the high sensitivity speaker.

On the other hand, the amplitude of the noise cancelling signal SNC is not limited, and sensitivity corresponding to the noise cancelling signal SNC of which the amplitude is not limited is set in the speaker 22L. Therefore, a sound output using the noise cancelling signal SNC can obtain an output sound pressure enough to cancel out incoming noise.

Thereby, the sound pressure limitation is obeyed, and the noise cancelling function is appropriately expressed.

As described above, in the earphone 2 according to the embodiment, the apparent speaker load varies in a case where the audio player 1 according to the embodiment is connected, and in a case where the other player 1X is connected.

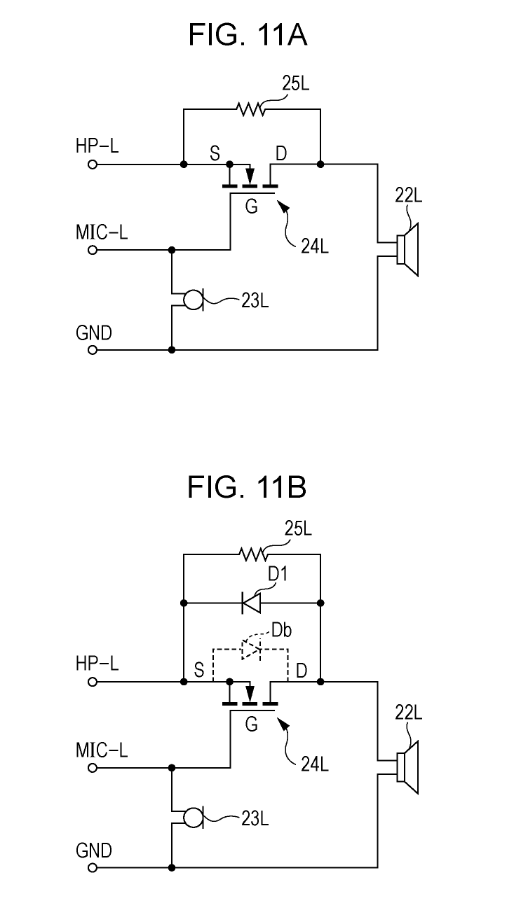

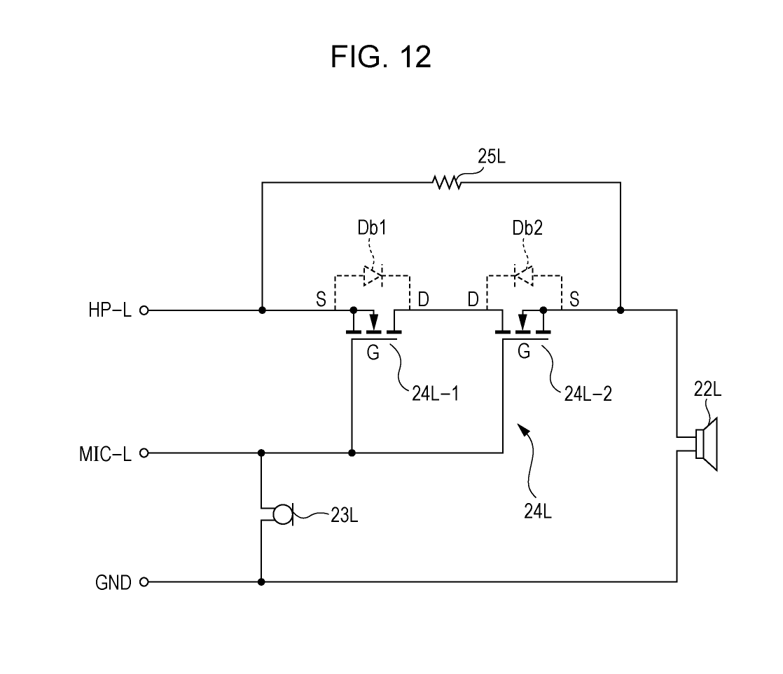

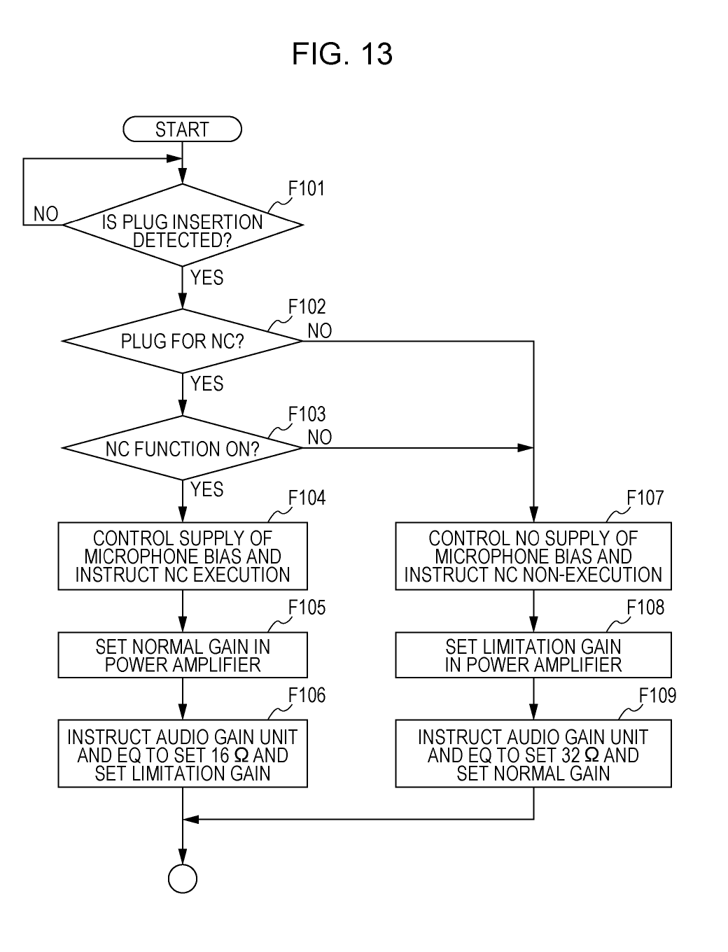

Detailed examples of the switch portions 24L and 24R for such an operation are shown in FIGS. 11A and 11B and FIG. 12. Description is made using only the L channel side, and is also true of the R channel side.

As shown in FIG. 11A, an N channel MOS-FET (Field Effect Transistor) is used as the switch portion 24L.

A gate of the FET as the switch portion 24L is connected to the microphone terminal MIC-L of the plug 21. In addition, source and drain thereof are connected between the L channel terminal HP-L and the speaker 22L.

Therefore, a gate voltage of the FET becomes a low level (ground level) when connected to the other player 1X, and becomes a high level (bias voltage level) when connected to the audio player 1, and thus the FET is turned on and off as shown in FIGS. 10A and 10B.

With this mechanism, the earphone 2 can be used as a speaker device having low sensitivity (resistance value 32 Ω) when connected to the other player 1X and a speaker device having high sensitivity (resistance value 16 Ω) when connected to the audio player 1.

FIG. 11B shows a modified example of the switch portion 24L. This is an example where a diode D1 is added in a direction reverse to a parasitic diode in consideration of the presence of the parasitic diode (body diode) component Db of the MOS-FET.

If the switch portion 24L is configured only using the FET as in FIG. 11A described above, in a case where an output voltage of the audio signal and the noise cancelling signal is excessively large, a current flows through the parasitic diode Db of the FET, and, as a result, the leakage current of the parasitic diode Db and a current flowing through the resistor 25L disposed in parallel may sound the speaker 22L.

At this time, the current flows only in the forward direction of the parasitic diode Db, and thus a waveform having one-sided distortion can be obtained at the speaker 22L end. This causes odd-numbered order strain, which thus is not preferable in terms of sound quality.

The diode D1 is connected in order to alleviate it and give even-numbered order strain as shown in FIG. 11B.

However, this is limited to the spirit of a case where an input signal to the speaker 22L is excessive, and thus there is no problem even using only the FET as shown in FIG. 11A in most cases.

As still another example, in order to completely remove a leakage current due to the MOS-FET, the switch portion 24L may have a configuration shown in FIG. 12. That is to say, the switch portion 24L is formed by two FETs 24L-1 and 24L-2 which are connected in series to each other.

The respective gates of the FETs 24L-1 and 24L-2 are connected to the microphone terminal MIC-L.

A source of the FET 24L-1 is connected to the L channel terminal HP-L, and a drain thereof is connected to a drain of the FET 24L-2. A source of the FET 24L-2 is connected to the speaker 22L. Thereby, current directions of the parasitic diodes Db1 and Db2 are made to be opposite to each other.

With this configuration, an influence of the leakage current can be removed.

As above, although an example of using the FET as the detailed example of the switch portions 24L and 24R has been described, the present disclosure is not limited thereto. For example, the same switch portions 24L and 24R can be also implemented using, for example, a general analog switch (transmission gate) or a relay circuit. When the earphone 2 is constituted only by passive circuits, the switch portions are preferably turned on and off depending on presence or absence of a bias voltage from the microphone terminals MIC-L and MIC-R.

### 6. Process in Audio Player (Type I and II)

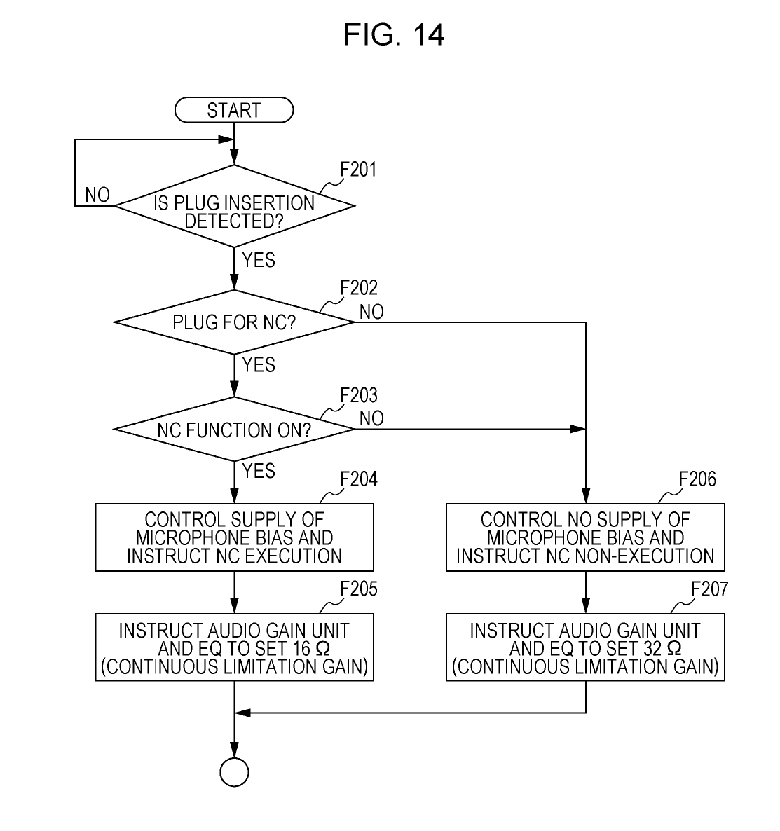

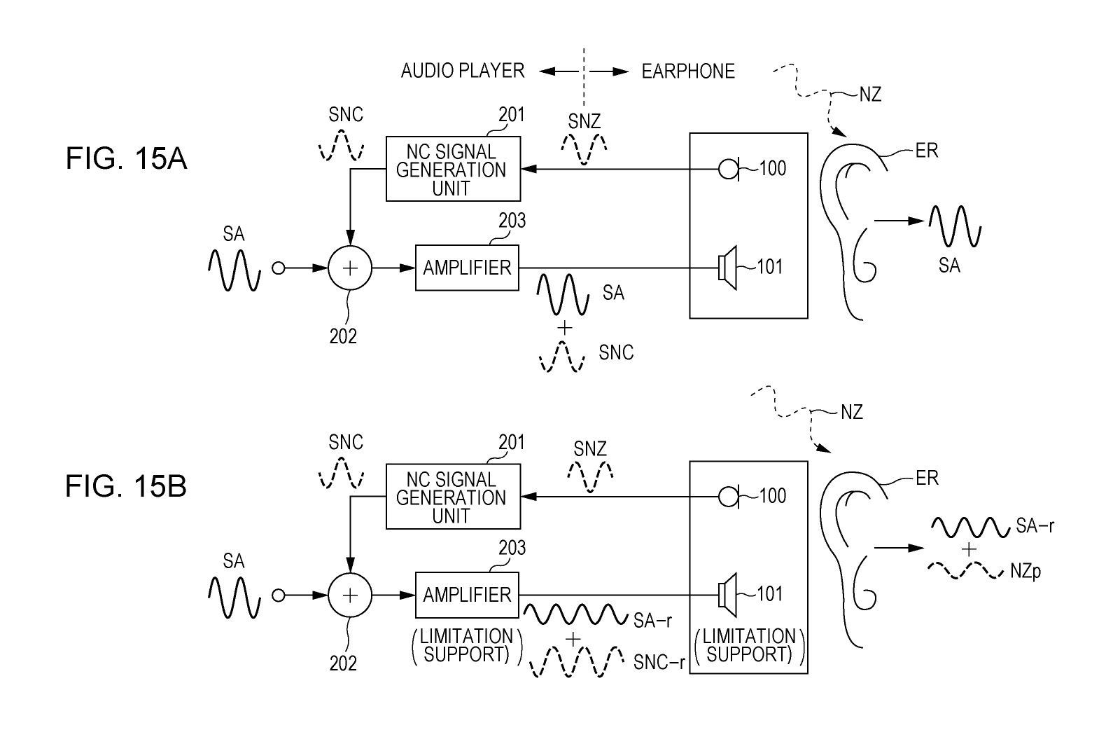

The operations of the audio player 1 and the earphone 2 according to the embodiment described above are realized by the control unit 31 performing the process shown in FIG. 13 (a case of the type I) or the process shown in FIG. 14 (a case of the type II) in the audio player 1.

First, the process performed by the control unit 31 in a case of the type I described with reference to FIGS. 7A and 7B will be described with reference to FIG. 13.

In step F101, the control unit 31 detects insertion of the plug. That is to say, detection information from the connection detection unit 40 is checked.

The connection detection unit 40 detects terminal voltages of the microphone terminals MIC-L and MIC-R as described above, and thereby detects whether or not an earphone is connected, and whether a connected earphone is the earphone 2 according to the embodiment or the other earphone 2X.

If the plug connection is detected, the control unit 31 divides the process depending on the connected earphone in step F102. That is to say, if the earphone 2 having the NC function is connected, the control unit 31 performs a process is step F103, and if the other earphone 2X not having the NC function, performs a process in step F107.

If the other earphone 2X is connected, the control unit 31 performs microphone bias OFF setting and an NC non-execution instruction in step F107. That is to say, the control unit 31 instructs the microphone bias unit 38 not to apply a bias voltage using the control signal CT5, and instructs the NC signal generation unit 39 not to generate the NC signal using the control signal CT7. In addition, the control unit 31 instructs the synthesis portion 36 not to perform synthesis of the NC signal using the control signal CT3.

In step F108, the control unit 31 instructs a limitation gain according to the sound pressure limitation as a gain of the power-up stage using the control signal CT4 for the DAC and amplifier portion 37.

Further, in step F109, the control unit 31 controls the equalizer 34 and the audio gain portion 35 to be set according to the other earphone 2X using the control signals CT1 and CT2. For example, frequency characteristic and gain settings for the speaker load 32 Ω are instructed. In addition, the gain limitation in the audio gain portion 35 is not performed.

Through the controls in steps F107 to 109, music or the like is reproduced and output in the state described with reference to FIG. 7A.

On the other hand, if the earphone 2 is connected, first, the control unit 31 checks whether or not the NC function is in an ON state in step F103. For example, ON and OFF states of the NC function may be selected by, for example, a user operation. If the NC function is in an OFF state, the same processes as in the case where the other earphone 2X is connected is preferable, and thus the processes in steps F107 to F109 are performed.

If the NC function is in an ON state, the control unit 31 performs a microphone bias supply control and an NC execution instruction in step F104.

That is to say, the control unit 31 instructs the microphone bias unit 38 to apply a bias voltage using the control signal CT5, and instructs the NC signal generation unit 39 to start generating the NC signal using the control signal CT7. In addition, the control unit 31 instructs the synthesis portion 36 to perform synthesis of the NC signal using the control signal CT3.

When the bias voltage starts being applied to the microphone terminals MIC-L and MIC-R, the switch portions 24L and 24R is turned on in the earphone 2, and thus the earphone 2 functions as a high sensitivity speaker.

In step F105, the control unit 31 instructs a normal gain instead of the limitation gain as a gain of the power-up stage using the control signal CT4 for the DAC and amplifier portion 37.

Further, in step F106, the control unit 31 controls the equalizer 34 and the audio gain portion 35 to be set according to the earphone 2 using the control signals CT1 and CT2. For example, frequency characteristic and gain settings for the speaker load 16 Ω are instructed. In addition, the control unit 31 instructs the audio gain portion 35 to limit a gain. That is to say, the instruction is performed such that the limitation gain according to the sound pressure limitation is given to the audio signal.

Through the controls in steps F104 to F106, music or the like is reproduced and output, and the noise cancelling operation is performed in the state described with reference to FIG. 7B.

Next, the process performed by the control unit 31 in a case of the type II described with reference to FIGS. 8A and 8B will be described with reference to FIG. 14.

In step F201, the control unit 31 detects insertion of the plug. That is to say, detection information from the connection detection unit 40 is checked.

If the plug connection is detected, the control unit 31 divides the process depending on the connected earphone in step F202. That is to say, if the earphone 2 having the NC function is connected, the control unit 31 performs a process is step F203, and if the other earphone 2X not having the NC function, performs a process in step F206.

If the other earphone 2X is connected, the control unit 31 performs microphone bias OFF setting and an NC non-execution instruction in step F206. That is to say, the control unit 31 instructs the microphone bias unit 38 not to apply a bias voltage using the control signal CT5, and instructs the NC signal generation unit 39 not to generate the NC signal using the control signal CT7. In addition, the control unit 31 instructs the synthesis portion 36 not to perform synthesis of the NC signal using the control signal CT3.

In step F207, the control unit 31 controls the equalizer 34 and the audio gain portion 35 to be set according to the other earphone 2X using the control signals CT1 and CT2. For example, frequency characteristic and gain settings for the speaker load 32 Ω are instructed.

Through the controls in steps F206 and F207, music or the like is reproduced and output in the state described with reference to FIG. 8A.

On the other hand, if the earphone 2 is connected, first, the control unit 31 checks whether or not the NC function is in an ON state in step F203. If the NC function is in an OFF state, the same processes as in the case where the other earphone 2X is connected is preferable, and thus the processes in steps F206 and F207 are performed.

If the NC function is in an ON state, the control unit 31 performs a microphone bias supply control and an NC execution instruction in step F204.

That is to say, the control unit 31 instructs the microphone bias unit 38 to apply a bias voltage using the control signal CT5, and instructs the NC signal generation unit 39 to start generating the NC signal using the control signal CT7. In addition, the control unit 31 instructs the synthesis portion 36 to perform synthesis of the NC signal using the control signal CT3.

When the bias voltage starts being applied to the microphone terminals MIC-L and MIC-R, the switch portions 24L and 24R is turned on in the earphone 2, and thus the earphone 2 functions as a high sensitivity speaker.

Further, in step F205, the control unit 31 controls the equalizer 34 and the audio gain portion 35 to have settings according to the earphone 2 using the control signals CT1 and CT2. For example, frequency characteristic and gain settings for the speaker load 16 Ω are instructed.

Through the controls in steps F204 and F205, music or the like is reproduced and output, and the noise cancelling operation is performed in the state described with reference to FIG. 8B.

In addition, in a case of the type II, the gain limitation according to the sound pressure limitation is normally performed by the audio gain portion 35. In addition, the continuous gain limitation is not performed at the power-up stage of the DAC and amplifier portion 37. For this reason, a control in a sense of the gain limitation control according to the connected earphone is not necessary.

The process example of each of the types I and II has been described above. The audio player 1 side performs an operation based on the control, and thus reproduced sound supplied to the sense of hearing of a user is output with a sound pressure obeying the sound pressure limitation even if any one of the earphone 2 and the other earphone 2X is connected.

In addition, in a case where the earphone 2 is connected and the NC function enters an ON state, a gain of the NC signal is not limited, thereby achieving an appropriate noise cancelling effect.

In addition, in a case of the type I, there is an advantage in that amplifier noise is reduced when the other earphone 2X is connected. Typically, electric noise generated from the amplifier depends on the magnitude of a gain of the amplifier itself. Therefore, the type I where the gain limitation is performed at the power-up stage when the other earphone 2X is connected can decrease the amplifier noise.

On the other hand, in a case of the type II, the gain limitation according to the sound pressure limitation is normally performed by the audio gain portion 35, and the gain limitation is not performed in the power-up process. For this reason, there is an advantage in that a change control according to an earphone is not necessary and a process load is small.

### 7. Modified Example

Although the embodiment has been described as above, the sound output device (the audio player 1) and the speaker device (the earphone 2) may have various modified examples.

First, in the audio player 1, connection detection for each earphone type may use methods other than the detection of terminal voltages of the microphone terminals MIC-L and MIC-R. For example, a mechanical detection or an optical detection is possible depending on a plug form.

In addition, the jack and plug of the audio player 1 and the earphone 2 are not limited to the five-pole terminals. For example, terminals of six or more poles may be configured. However, a shape which can be connected to typical three-pole plug and jack is preferable, and, preferably, the microphone terminals are connected to the ground, or are not connected to at least any terminal when connected to the other player 1X and the other earphone 2X. In addition, the audio player 1 may be a monoral type player.

In addition, the earphone 2 may be not a so-called earphone type but a headphone type.

In addition, although an example of the feedforward scheme has been described in the embodiment in relation to the NC function, a feedback scheme may be used.

In a case of the above-described feedforward scheme, incoming noise is collected by the microphones 23L and 23R; however, in the feedback scheme, for example, the microphones are disposed inside a headphone housing. After speaker output sound and noise sound are collected, an NC signal obtained by extracting the noise sound component and reversing the phase thereof is added to an audio signal. At this time, the amplitude of the NC signal is not made to be limited, thereby achieving the same effect as in a case of the feedforward scheme.

In addition, the NC signal generation unit 39 may generate the NC signal through digital filtering or analog filtering.

In addition, the sound signal output device according to the embodiment of the present disclosure has been exemplified by the audio player 1; however, the sound signal output device may be a reception device or a radio tuner which does not have a sound source portion inside, and receives and outputs a sound signal transmitted from, for example, an external sound source.

The present disclosure contains subject matter related to that disclosed in Japanese Priority Patent Application JP 2010-286962 filed in the Japan Patent Office on Dec. 24, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A sound signal output device comprising:
a noise cancelling signal generation unit that generates a noise cancelling signal from a sound collecting signal using a microphone provided in a connected speaker device; and
a sound signal output processing unit that synthesizes a main sound signal with the noise cancelling signal and amplifies the synthesized signal, performs an output limitation process for sound pressure limitation for the main sound signal, and does not perform the output limitation process for the noise cancelling signal, when an output sound signal for a connected speaker device is generated.

2. The sound signal output device according to claim 1, further comprising a connection detection unit that detects whether or not a connected speaker device is a noise cancelling supporting speaker device which outputs a sound collecting signal using the microphone,
wherein the sound signal output processing unit includes
a main sound gain circuit that performs a gain process for the main sound signal;
a synthesis circuit that synthesizes an output from the main sound gain circuit with the noise cancelling signal; and
a power-up circuit that performs an output gain process for an output from the synthesis circuit, and
wherein the sound signal output processing unit makes the main sound gain circuit perform the output limitation process and the power-up circuit not perform the output limitation process if connection of the noise cancelling supporting speaker device is detected by the connection detection unit, and makes the main sound gain circuit not perform the output limitation process and the power-up circuit perform the output limitation process if connection of a speaker device other than the noise cancelling supporting speaker device is detected by the connection detection unit.

3. The sound signal output device according to claim 2, further comprising a microphone bias unit that supplies a bias voltage for driving the microphone to the noise cancelling supporting speaker device which is connected if connection of the noise cancelling supporting speaker device is detected by the connection detection unit.

4. The sound signal output device according to claim 3, further comprising at least a terminal for the output sound signal, a terminal for the bias voltage, and a ground terminal, as a connection terminal structure with a connected speaker device,
wherein, when the noise cancelling supporting speaker device is connected, the microphone bias unit supplies the bias voltage from the terminal for the bias voltage, and the noise cancelling signal generation unit generates the noise cancelling signal based on a sound collecting signal component obtained from the terminal for the bias voltage.

5. The sound signal output device according to claim 4, wherein, when a speaker device other than the noise cancelling supporting speaker device is connected, the terminal for the bias voltage is short-circuited to the ground terminal.

6. The sound signal output device according to claim 1, wherein the sound signal output processing unit includes
a main sound gain circuit that performs a gain process for the main sound signal;
a synthesis circuit that synthesizes an output from the main sound gain circuit with the noise cancelling signal; and
a power-up circuit that performs an output gain process for an output from the synthesis circuit, and
wherein the sound signal output processing unit performs the output limitation process using the main sound gain circuit.

7. The sound signal output device according to claim 6, further comprising:
a connection detection unit that detects whether or not a connected speaker device is a noise cancelling supporting speaker device which outputs a sound collecting signal using the microphone; and
a microphone bias unit that supplies a bias voltage for driving the microphone to the noise cancelling supporting speaker device which is connected if connection of the noise cancelling supporting speaker device is detected by the connection detection unit.

8. A speaker device comprising:
a speaker unit that outputs sound based on an output sound signal supplied from a connected sound signal output device;
a microphone that collects incoming noise using a bias voltage supplied from a connected sound signal output device;
a switch unit that is installed on a supply path of the output sound signal to the speaker unit and is turned on or off depending on the bias voltage; and
a sensitivity reducing resistive element that is connected in parallel to the switch unit on the supply path.

9. The speaker device according to claim 8, wherein the switch unit is formed using a transistor element which is turned on or off depending on the bias voltage.

10. The speaker device according to claim 9, wherein, in the switch unit, a diode is connected in parallel to the transistor element in a direction reverse to a current direction of a parasitic diode component of the transistor element.

11. The speaker device according to claim 9, wherein, in the switch unit, two FETs as the transistor element are connected in series to each other in a state where leakage currents of parasitic diodes are reverse to each other.

12. The speaker device according to claim 8, further comprising at least a terminal for the output sound signal, a terminal for the bias voltage, and a ground terminal, as a connection terminal structure with a connected sound signal output device.

13. A sound output system comprising:
a sound signal output device; and
a speaker device connected to the sound signal output device,
wherein the sound signal output device includes
a noise cancelling signal generation unit that generates a noise cancelling signal from a sound collecting signal using a microphone provided in the speaker device; and
a sound signal output processing unit that synthesizes a main sound signal with the noise cancelling signal and amplifies the synthesized signal, performs an output limitation process for sound pressure limitation for the main sound signal, and does not perform the output limitation process for the noise cancelling signal, when an output sound signal for the connected speaker device is generated, and
wherein the speaker device includes
a speaker unit that outputs sound based on an output sound signal supplied from the sound signal output device;
the microphone that collects incoming noise using a bias voltage supplied from the sound signal output device;
a switch unit that is installed on a supply path of the output sound signal to the speaker unit and is turned on or off depending on the bias voltage; and
a sensitivity reducing resistive element that is connected in parallel to the switch unit on the supply path.

14. An output method of a sound signal for a connected speaker device comprising:
synthesizing a main sound signal with a noise cancelling signal generated from a sound collecting signal using a microphone provided in the speaker device and amplifying the synthesized signal; and
performing an output limitation process for sound pressure limitation for the main sound signal, and not performing the output limitation process for the noise cancelling signal, when an output sound signal to the connected speaker device is generated.
